(19) United States
(12) Patent Application Publication
(10) Pub. No.: US 2015/0347686 A1
(43) Pub. Date: Dec. 3, 2015

(54) METHOD AND APPARATUS FOR A VIDEO MEDICAL RECORD

(71) Applicant: Moventics Inc., Wylie, TX (US)

(72) Inventors: Rizalito Ortiz, Wylie, TX (US); Abhishek, Pune (IN)

(73) Assignee: MOVENTICS INC., Wylie, TX (US)

(21) Appl. No.: 14/726,377

(22) Filed: May 29, 2015

Related U.S. Application Data
(60) Provisional application No. 62/006,156, filed on May 31, 2014.

(51) Int. Cl. G06F 19/00; G06F 17/30; G06F 3/0482; H04L 29/08; G06F 3/0484

(52) U.S. Cl. CPC G06F 19/322; H04L 67/10; G06F 3/04842; G06F 3/0482; G06F 17/30849

(57) ABSTRACT

A video medical record (VMR) system provides a means and method for multiple users of a central server and multiple remote user devices to mutually create, edit, store, compare, and share texts, videos, stills and/or audios relating to a patient. The VMR system includes the use of existing mobile devices such as a laptop, tablet, laptop-tablet hybrid, phablet, tablet-phone hybrid, phone, or other camera equipped mobile electronics. The VMR system provides an intuitive graphical user interface (GUI) on the mobile device that allows a user to create, edit, store, compare and share one or more videos of a patient quickly and easily. The VMR system and GUI can be installed as a software/application (also called an “app”) that is installed on a mobile device's operating system (iOS, Android, Windows mobile, etc).

### RELATED APPLICATIONS

The present application is related to U.S. Provisional Patent Application Ser. No. 62006156, filed on May 31, 2014, pursuant to 35 USC 119.

A portion ref the disclosure of this patent document contains material which is subject to copyright protection. The copyright owner has no object to the facsimile reproduction by anyone of the patent document or the patent disclosure, as it appears in the Patent and Trademark Office patent file or records, but otherwise reserves all rights of copyright whatsoever.

### BACKGROUND

1. Field of the Technology

The present invention relates to an electronic medical records system, and more specifically, to a method and system of creating, editing, storing, comparing, and sharing a video medical record of a patient.

2. Description of the Prior Art

Health care professionals are increasingly relying on electronic media to store and convey important information about their patient's health and treatment programs. Nearly all electronic medical records contain textual information about the patient, such as the patient's name, weight, allergies, prescription information, etc. Media in the form of pictures, x-rays or other images showing the injury itself can also be used to document the patient's health and treatment.

Traditional medical records used by health care professionals do not use video. In particular, the field of physical therapy still relies on text and pictures for their patients' medical record Yet media in the form of videos in the electronic medical record of a patient can be a beneficial tool. Video is particular useful for patients who are undergoing physical therapy. Patients under physical therapy are relearning or recovering the ability to perform certain physical movements or bodily tasks. For these patients, a video tends to illustrate their ability to perform these movements much better than a still picture or written words. For the health care professional such as the patient's physician, nurse, or physical therapist, a video medical record would be a valuable tool to document the patient's current medical state, recovery and progress. Also, because of the visual nature of video, health care professionals and patients alike can use it to convey information that would otherwise be difficult to understand via written text or spoken word. Therefore, what is needed is a quick and easy way to create and store video in a patient's medical record.

If one video in the medical record of a patient is valuable, then multiple videos taken separately as the patient is treated over time is even better. The health care professional and the patient herself can view different videos taken over time as an indicator of the treatment's effectiveness and patient's progress. Additionally, the ability to play multiple videos at the same time in comparison with each other side by side or overlapping would be highly useful to show patient progress, improvement, or lack thereof. What is needed then, is a quick and easy way to record multiple videos of a patient and play them separately or in comparison with each other.

Traditional electronic medical records can be accessed only by the health care professional who has access to their internal medical records system. Oftentimes the professional who access these records have no easy way of sharing certain information with the patient or other concerned parties such as the patient's friends, family or other health care professionals, who do not have access to the internal medical records system. In the usual case, the patient or concerned party will only see the information that the health care professional shows them while they are physically at the hospital, clinic or in the patient's room. This is true even though they have the necessary clearance to access the patient's medical information. If the patient asks for specific information, the health care professional may be able to print in on paper. However, this is particularly problematic if the information sought is contained in a video medical record. A paper handout is an undesirable and inefficient way to try to convey the information contained in a video. What is needed is a quick and easy way to share the video medical record with the patient and other concerned parties.

In addition, health care professionals are increasingly providing care to patients in the field, namely, outside the clinic or hospital. For a patient, this could mean receiving care in the patient's own home or in a remote area wherever the patient happens to be. Without access to the hospital's equipment and internal medical record system however, there is no easy way for a health care professional to create and store video medical records. As mobile devices such as laptops, tablets, and phones become more powerful, the potential to use them to create and store video medical records is a possibility with the invention described below. What is needed is a quick and easy way to use existing mobile devices to create, edit, view, store, compare, and share video in a patient's medical record.

Therefore, the present invention is directed to address the aforementioned and unfulfilled needs. The instant invention addresses these needs by providing a method and system of creating, editing, storing, comparing and sharing video of a patient using mobile devices.

### BRIEF SUMMARY

The illustrated embodiments of the present invention include an electronic medical records system. Specifically, it is a video medical record (VMR) system which provides a quick and easy method of creating, editing, storing, comparing, and sharing video of a patient.

The illustrated embodiments of the present invention include a method of creating, editing, storing, comparing, and sharing video of a patient.

The illustrated embodiments of the present invention include a device(s) for creating, editing, storing, comparing, and sharing video of a patient.

The VMR system includes the use of existing mobile devices such as a laptop, tablet, laptop-tablet hybrid, phablet, tablet-phone hybrid, phone, or other camera equipped mobile electronics. The VMR system provides an intuitive graphical user interface (GUI) on the mobile device that allows a user to create, edit, store, compare, and share one or more videos of a patient quickly and easily. The VMR system and GUI can be installed as a software/application (also called an “app”) that is installed on a mobile device's operating system (iOS, Android, Windows mobile, etc).

The central server includes the patients' electronic medical records, including pictures, video and audio.

The user device emote from the central server includes a graphical user interface (GUI) that allows a user to add a new patient retrieve and view all or part of the patient's existing medical record, edit the patient's existing medical record, or create a new medical record by inputting the patient's identification information such as the patient's name, email address, medical record number, or annotating textual information.

The user device remote from the central server includes a graphical user interface (GUI) that allows a user to: browse or a list of patients or search existing patients for a specific patient's medical record information provided by the central server; view videos, images, or reports of the selected patient; listen to any audio record present; or add or edit information to the medical record of the selected patient including vital measurements, diagnosis, treatment, or progress reports of that patient, texts, pictures, or video.

The user device remote from the central server includes a graphical user interface (GUI) that allows a user to access only specific functions and information, or all functions and information provided by central server depending on a qualification given to the user.

The user device remote from the central server includes a graphical user interface (GUI) that allows a user to record a video, edit a video and perform data or recording functionalities, notify another user when there is new information or new update on the central server, or determine whether or not the patient has seen a selected video.

The user device remote from the central server includes a graphical user interface (GUI) that allows a user to view pictures/images, video, listen to audio, use a website provided by the central server to register, view a patient's medical record, or send an email or notification to the patient or selected health care professionals, users, or concerned parties using social media.

The user device remote from the central server includes a graphical user interface (GUI) that allows a user to rename a saved video, viewed and played by itself, adjust a speed at which the video is played, play a video in comparison with other videos from the same patient or different patients, display two or more videos on the same screen or viewing area, side by side or in close proximity to each other, play each video independently or simultaneously while in close proximity to a display of another video.

The user device remote from the central server includes a graphical user interface (GUI) that allows a user to edit and manipulate an image/picture, video, or audio when viewed by itself or while in comparison with other images/pictures or videos, add pictures, drawings, markings, shapes or text, angle recognition, free drawing pencil marks, or four point angles to one or more selected frames of a video, edit one or more selected frames of the video, add a new frame with edits inserted between existing frames, add one layer or multiple layers of edits to a frame or multiple frames, add different edits separately to each frame of a video, save an edited video as an additional new video or replace an original video, take a snapshot of a frame of the video and save it as a picture, or show videos or pictures in comparison with other videos or pictures from the same patient or different patients.

The communication link includes a local area network, wide area network, cloud computing network, or internet connected wirelessly using wi-fi, cellular technology, satellite, or any wireless protocols.

The illustrated embodiments of the invention include a method of using an electronic medical records system including a central server and at least one user device remote from the central server comprising the steps of: creating a video medical record (VMR) in the video medical record system; storing the video medical record (VMR) in the video medical record system; editing the video medical record (VMR) in the video medical record system; comparing the video medical record (VMR) in the video medical record system; and sharing the video medical record (VMR) in the video medical record system.

The steps of creating, storing, editing, comparing, and sharing the video medical record (VMR) in the video medical record system include creating, storing, editing, comparing, and sharing the video medical record (VMR) in a desktop computer, hospital server, laptop, tablet, laptop-tablet hybrid, phablet, tablet-phone hybrid, phone, or a camera equipped mobile device.

The steps of creating, storing, editing, comparing, and sharing the video medical record (VMR) in the video medical record system include creating, storing, editing, comparing, and sharing one or more videos of a patient using a graphical user interface (GUI) in the at least one user device remote from the central server.

The steps of creating, storing, editing, comparing, and sharing the video medical record (VMR) in the video medical record system include creating, storing, editing, comparing, and sharing a patients' electronic medical records including pictures, video or audio.

The steps of creating, storing, editing, comparing, and sharing the video medical record (VMR) in the video medical record system include using a graphical user interface (GUI) to edit and manipulate an image/picture, video, or audio when viewed by itself or while in comparison with other images/pictures or videos, add pictures, drawings, markings, shapes or text, angle recognition, free drawing pencil marks, or four point angles to one or more selected frames of a video, edit one or more selected frames of the video, add a new frame with edits inserted between existing frames, add one layer or multiple layers of edits to a frame or multiple frames, add different edits separately to each frame of a video, save an edited video as an additional new video or replace an original video, take a snapshot of a frame of the video and save it as a picture, or show videos or pictures in comparison with other videos or pictures from the same patient or different patients.

The steps of creating, storing, editing, comparing, and sharing the video medical record (VMR) in the video medical record system include using a graphical user interface (GUI) to rename a saved video, viewed and played by itself, adjust a speed at which the video is played, play a video in comparison with other videos from the same patient or different patients, display two or more videos on the same screen or viewing area, side by side or in close proximity to each other, play each video independently or simultaneously while in close proximity to a display of another video.

The steps of creating, storing, editing, comparing, and sharing the video medical record (VMR) in the video medical record system include using a graphical user interface (GUI) to view pictures/images, video, listen to audio, use a website provided by the central server to register, view a patient's medical record, or send an email or notification to the patient or selected health care professionals, users, or concerned parties using social media.

The steps of creating, storing, editing, comparing, and sharing the video medical record (VMR) in the video medical record system include using a graphical user interface (GUI) to record a video, edit a video and perform data or recording functionalities, notify another user when there is new information or new update on the central server, or determine whether or not the patient has seen a selected video.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a flow chart for data transfer/communication between mobile devices with the VMR GUI app, desktop computer, the VMR central server, and other servers.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

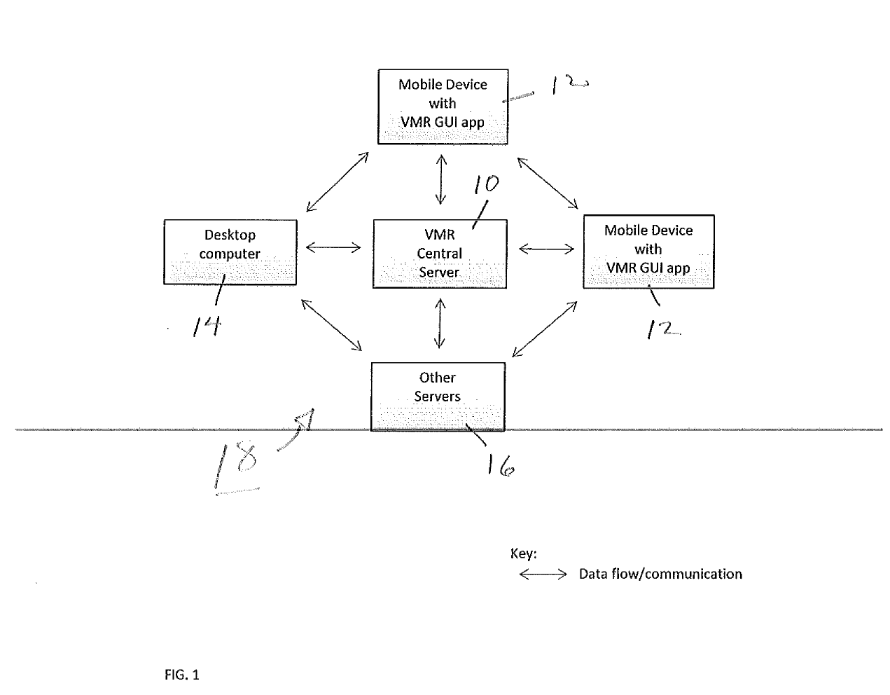

With reference to FIG. 1, the illustrated embodiments of the present invention include a VMR central server 10 which is comprised of computer hardware and software to allow communications and data exchange with one or more users' mobile devices 12. The VMR central server 10 contains copies of one or more patients' electronic medical records, including pictures and videos, which can be accessed or edited by the users' mobile devices 12. The VMR central server 10 is updated automatically with uploaded information that a user creates, edits or stores using the one or more mobile devices 12. A copy of all or part of the information stored on the VMR central server 10 may also be stored on the mobile device 12 itself. Multiple users and their mobile devices 12 may connect to the VMR central server 10 simultaneously. At the same time, a user using a desktop computer 14 can access the information in the VMR central server 10 using an internet connection and conventional browser (Internet Explorer, Chrome, Firefox, Safar, etc.). Other computer servers 16 may share data with the VMR central server 10. The collection of devices of FIG. 1 is denoted collectively as VMR system 18.

In one embodiment, a health care professional such as a physical therapist uses an iPad tablet, included as a mobile device 12, to download and install the VMR system app onto their iPad (Appendix B, p.1). In another embodiment a doctor uses a desktop computer 14 and browser to communicate with the VMR central server 10 to access the patients' electronic medical records, including pictures, video and audio. in yet another embodiment, a hospital's server 16 shares data to and from the VMR central server 10.

By means of the VMR system 18 a user starts by using the VMR system's GUI sign up screen provided by central server 10 on a mobile device 12 to create a new account, or log into an existing account, with a username and password (Appendix A p.3, Appendix D p.1). A user can be a health care professional, patient, and/or concerned party. A concerned party can be the patients friend or relative, spouse, or legal or insurance representative. In one embodiment, the user's credentials and login information is authenticated by the VRM central server 10. Once logged in to the VMR system 18, the user can add a new patient, retrieve and view all or part of a patients existing medical record, edit a patients existing medical record, or create a new one by inputting the patient's identification information such as his name, email address, medical record number, or other textual information (Appendix A p.4, Appendix D, p.2, Appendix E p.5, Appendix F, p.5, Appendix F, p.6).

Alternatively, the user can browse or a list of patients or search existing patients for a specific patient's medical record information provided by central server 10 (Appendix E p.2, Appendix D p.3, Appendix E p.7, Appendix F p.7). Once found, the user can view the videos, images, and reports of a selected patient (Appendix E p.2, Appendix E p.3, Appendix E p.8, Appendix F, p.8). If any audio is present, the user can listen to the audio as well. At any time after the user is logged in, the VMR GUI provided by central server 10 allows the user to add or edit other information to the medical record of the selected patient such as vital measurements, diagnosis, treatment, and progress reports of that patient, including texts, pictures, and video (Appendix D p.4. Appendix E p.4, Appendix E p.6). In one embodiment, the VMR GUI provided by central server 10 will present the user with diagnosis which can be selected, such as CHF, CVA/stroke, SCI, etc (Appendix A, p 4).

In one embodiment, a physical therapist starts the VMR system app on his iPad tablet 12, enters his username and password, and enters a patient's personal identifier to view the patients information including pictures/images, video, audio, or reports provided by central server 10 (Appendix F p.1, Appendix F p.2, Appendix F p.4). Reports can include whatever information is necessary to convey patient treatment, diagnosis, and/or recovery over a period of time. In one embodiment, a physical therapist creates, views, or shares with central server 10 the patient's progress in gait/walking (Appendix F p.4). Depending on the user, the VMR system app will allow the user to access only specific functions and information, or all functions and information provided by central server 10.

In one embodiment, a patient acting as a user can use the VMR system app on a mobile device 12 to view information and write comments (Appendix C). The app may notify the patient when a new video is loaded onto central server 10 (Appendix C).

In one embodiment the physical therapist will use the VMR system app to record video, edit videos and perform all the data or recording functionalities allowed by central server 10, notify another user when there is new information or new update, and determine whether or not the patient has seen the video (Appendix C).

In another embodiment a user can use the website of VMR system 18 to view pictures/images, video, or listen to audio (Appendix C). A physical therapist can use the website to register, view their patients, view reports, and send email and notification to patients (Appendix C). The VMR system 18 will be integrated into social media so that certain information can be sent to other health care professionals, users, or concerned parties using social media such as Facebook, Twitter, Instagram, etc. (Appendix C).

Once a medical record of a specific patient is accessed, pictures, video, or audio can be created and added to the medical record on central server 10 in any number of ways (Appendix A p.9). In one example, the VMR GUI has a video record function which is activated to start recording video using a mobile device 12 which video will be automatically added and saved to the patient's existing record when the video recording is finished (Appendix A p.5, Appendix E p.2).

Alternatively, the mobile device's original user interface is used to go to a camera or video function of device 12 to begin the recording of the patient. The video can record the patient at rest, play, work, or while the patient performing a certain physical movement or bodily task. The video camera of device 12 can capture any number of views, or any combination thereof. In one embodiment, the video captures the whole body of the patient. In another embodiment, the video captures a particular body part such as an arm or leg. In yet another embodiment, the video captures the apparatus that the patient is using, such as a fitness machine or respirator. Physical movements or bodily tasks include but are not limited to standing up, sitting down, walking, squatting, lifting, supine to sit, sit to supine, scooting forward, knee flexion, sit-ups, pushups, arm raises, gait training, etc. Additionally, what could be captured may be a basic bodily function, such as breathing or the patient's reaction to certain stimuli. The VMR GUI allows the user to manually type or input the description of the physical movement or bodily task. The description can be added as title or label for a video (Appendix E p. 2). In another embodiment, the VMR system will suggest and supply a list of physical movements or bodily tasks, which the user can select from as appropriate, including transitions such as ‘supine to sit’, ‘sit to supine’, ‘scooting forward’, etc. (Appendix A p.4).

The camera of the mobile device 12 may be positioned accordingly so that the image/picture, video, and/or audio can be optimized for the best orientation, such as portrait or landscape. In one embodiment using a tablet mobile device 12, the orientation of the video is in landscape, with the video lens near the left upper corner of the tablet 12. By positioning the camera of the mobile device 12 a certain way, the patient can take a picture or video of herself without the assistance of another person. In this way, a patient herself can create and, store pictures or videos in her own electronic medical record without the assistance of a health care professional and in whatever circumstance the patient chooses or needs to perform.

After saving the image/picture, video, and/or audio to the storage device included in the mobile device 12, it can be retrieved using the VMR GUI and then added to the patient's electronic medical record in central server 10 for viewing, editing, or sharing. A copy can be sent to the VMR central server 10 at any time. In the aforementioned manner, the illustrated embodiment of the present invention provides for quick and easy way to create and store video in a patient's medical record.

After a video is saved into the patient's medical record, it may be renamed (Appendix D p.7). A video can also be viewed and played by itself (Appendix D, p.5). The user may adjust the speed at which the video is played, including faster (more frames per second), slower (less frames per second) or regular speed (Appendix A p.6). A video can also be played in comparison with other videos from the same patient or different patients using the VMR GUI. In one embodiment, the comparison of videos is accomplished by displaying two or more videos on the same screen or viewing area, side by side or otherwise in close proximity to each other (Appendix A p.7, Appendix D p.6). The GUI will allow the user to play each video independently or all of them simultaneously while in close proximity to each other.

In one embodiment. the user will access the list or ‘gallery’ function or ‘camera roll’ the VMR GUI to see a listing of the available videos from one or more patients (Appendix E p.1, Appendix E p.2, Appendix D p.4). In one embodiment, a physical therapist can access the videos for a particular patient which shows the patient's gait training (Appendix E p.2). The user then selects two or more videos for comparison. In one embodiment, the videos selected can be noted by a check ark on the upper right corner of the video icon or thumbnail. The user will then select the “compare videos” function whereby the VMR GUI will present all the selected videos to be compared (Appendix A p.7, Appendix D p.6). The VMR GUI will allow the user to place the videos in any orientation or position relative to the others. In one embodiment, the videos are side by side, or one above the other (appendix A p.7). In another embodiment the videos can be overlaid with each other, but still both be seen, as the video layered on top will automatically become a semi-transparent overlay allowing the video underneath to still be seen as a background, similar to levels in conventional graphics software. Each video can be played independently or simultaneously with variable synchronization. In yet another embodiment, copies of the same video can be played in comparison with each other. This may be helpful if the user wants to compare different aspects of the same video for example, comparing the beginning of one video with the end of the same video. A user such as the health care professional or patient can compare videos taken at different times or stages of medical treatment. The comparison will be an indicator of the treatment efficacy and patient's progress. In this manner then, the present invention provides a quick and easy way to record multiple videos of a patient and play them separately or in comparison with each other.

An image/picture, video, or audio may be edited and manipulated at any time by the user. An image/picture or video can be edited whether it is viewed by itself or while in comparison with other images/pictures or videos (Appendix A p. 10, Appendix p. 8). Editing manipulation includes but is not limited to adding pictures, drawings, markings, shapes or text, angle recognition, free drawing pencil marks, and 4 point angles, etc. to one or more selected frames of the video. The edits can be added onto one or more selected frames of the video, or a new frame with edits can be inserted between existing frames. Each frame can have one layer or multiple layers of edits. The same edits can be added to multiple frames or the user may add different edits separately to each frame of a video. After editing, the user can save the edited video as an additional new video or replace the original video (Appendix A p. 10). The user can also take a snapshot of a frame of the video and save it as a picture as described below. Non-edited or edited videos (or pictures) can be shown in. comparison with other videos (or pictures) from the same patient or different patients in the VMR system of the current invention. A user can use the VMR GUI to edit the images/pictures or video, or a user can use third party software to edit them (Adobe Photoshop, Adobe Premiere, Microsoft Paint, Microsoft Movie Maker, etc.).

In one embodiment, the user uses the VMR GUI to add text to one or more frames of the video (Appendix A p.12). After selecting the desired frame, for example, by pausing the video on a particular frame or selecting a frame along the video scroll bar, the user selects the ‘option’ function to make the editing buttons appear on the left side of the frame of the video (Appendix A p. 11) The user will then select the ‘add text’ function and will add text to the video using the mobile device's keyboard or other input device to a text box (Appendix D p. 9). Once the text is added, the user selects ‘return’ on the keyboard and selects anywhere in the frame of the video where he wishes the text to be placed (Appendix A p.12). The text can be notes or thoughts on the patient's treatment and progress or any other information the user wants to convey.

In one embodiment, the user draws free hand on one or more frames of the video using a mouse or drawing tablet included in mobile device 12 (Appendix A p.15). After selecting the desired frame and selecting the ‘option’ function to make the editing buttons appear, the user will select the ‘drawing pencil’ function (Appendix A p.15). The user can then use an input device coupled to device 12 to draw anything by freehand, including any shape such as lines, circles, doodles, etc., and any handwritten text (Appendix D p.13). In the one embodiment, the user uses his finger or stylus on the mobile device's touch screen to draw. The drawings can be used to convey certain information and highlight certain areas of the video.

In another embodiment, the user may also add angle recognition reference points to one or more frames of the video (Appendix A p.12, Appendix D p.11). Angle recognition reference points enables the user to determine the relative angle of certain parts of the patient's body. Angle recognition reference markers include lines, dots, text or other shapes and graphics to aid in the analysis of an angle. Using the VMR GUI, a user can place the markers anywhere in the frame, including the patient's body prominences for proper placement of fulcrum and moving arms. In one embodiment, the patient is asked to do a physical movement such as a hip/knee flexion during the recording of a video. After the video is taken, the user selects a particular frame of the video for angle recognition of the patient's hip/knee flexion (Appendix A p.13). The user selects the ‘option’ function to make the editing buttons appear on the left side of the frame of the video, and then selects the angle recognition function (Appendix A p.13). The user places the angle recognition markers as appropriate, such as the patient's hip, knee, and ankle (Appendix A p.13). In this manner, the user can determine the angle of a hip/knee flexion for this particular patient. By comparing pictures or videos of that patient over time, a user can view how flexible the patient has become.

In another embodiment, the user may add four point angle recognition markers to one or ore frames of the video (Appendix A p.15, Appendix D p.14). Four point angle recognition enables the user to determine the angle of certain parts of the patient's body using two lines that intersect each other (Appendix A p.15). The lines can be placed where appropriate for the measurement. The angles at which the lines cross can be calculated or estimated. In one embodiment where the patient is asked to do a hip/knee flexion, a line is placed from the patient's head to her hip, while another line is placed from her hip to her knee (Appendix A p.15). The user can then determine using software or estimate by eye the desired angle and add that information to the patient's medical record.

A screenshot or picture of an edited or non-edited frame may be taken at any time (Appendix A p.14, Appendix D p.12) In one embodiment, the user pauses the video on a desired frame or selects a desired frame along the video scroll bar and selects the ‘option’ function to make the editing buttons appear on the left side of the frame of the video (Appendix A p.14). The user will then select the ‘snapshot’ function to take a picture of the desired frame of the video. In another embodiment, the user pauses the edited video during playback to take a picture of the frame with the edit.

In another embodiment, the user selects the ‘snapshot’ function to take a picture of a frame which has just been edited. After taking the snapshot the user has the option of saving or sharing the picture. By saving it will add the picture including any edits to the patient's electronic medical record in the VMR system 18. Non-edited or edited pictures can be shown in comparison with other pictures from the same patient or different patients in the VMR system 18.

A user can add audio to a particular image/picture, or video. This is done by using the built in microphone on the mobile device 12, or a microphone attached to the computer 14. In one embodiment, the physical therapist adds audio of his spoken notes, directed to a concerned party who accesses a patient's picture or video. In another embodiment, the patient's doctor adds audio instructions to the patient to perform a certain exercise. The audio can be played automatically when a user selects a particular picture or video for viewing, or the audio file can be selected by pressing ‘play’. Prerecorded audio such as music can also be added. The audio can replace the original audio of the video, or overlaid on top, so that a person watching the video can listen to the original video audio and the new audio added to it at the same time.

A health care professional can takes videos or pictures of the patient doing certain exercises and can create a customized exercise program. The video or picture is then edited. In the preferred embodiment, editing is done using the VMR GUI editing feature. The health care professional can add text or other information to prescribe a customized exercise program or regimen based upon what the patient is doing in the video or picture. The video or picture can then be saved in the patient's medical record in central server 10 and/or on the mobile device's storage/camera roll in device 12. From the VMR GUI or mobile device's user interface, the health care professional can message or email the videos or pictures directly to the patient or other concerned parties. In another embodiment, the user may further edit the video or picture using a third party software on their mobile device 12 or computer 14 before sending them the patient.

In another application of the present invention, the VMR system 18 is used for wound management. By taking videos and/or pictures of a patient's wound over time and comparing them, the health care professional may track the progress of the wound and aid in wound management.

In one embodiment of the present invention, a copy of all information in the VMR system 18 is stored on the VMR central server 10, which communicates and exchanges data with the mobile device 12 The mobile device 12 and the VMR central server 10 can be on a local area network, wide area network, cloud computing network, or connected to the Internet. In the preferred embodiment, the VMR central server 10 and all the electronic information and patient medical records are available to any device connected to the internet, and accessible with the proper log in credentials. The mobile device 12 and VMR central server 10 can be connected to the Internet wirelessly using wi-fi, cellular technology (CDMA, GSM, etc), satellite, or other wireless protocols. In that manner, the VMR system 18 provides instant and remote access to a patient's videos, pictures, and other medical information at any geographic location. A user may access and update the information in a patient's medical record by logging into the VMR system 18 at any time.

Under the VMR system 18, any information in a patient's medical record may be shared with another user or concerned party at any time. The concerned party may log in to the VMR central server 10 on their own mobile device 12 to access information in the patient's medical record. A user can use the VMR GUI or mobile device interface to notify a concerned party that a new picture/image, audio, or video s available for viewing/listening upon login. In one embodiment, a doctor receives a notification on a mobile device 12 from the physical therapist that a patient has a new image/picture, video, or audio recording in the electronic medical record on server 10. A notification can be a text message, email, call, or automated call. In another embodiment a physical therapist adds new information to the patient's medical record and the VMR system 18 automatically sends a notification to a concerned party that the info is available for viewing or listening. In yet another embodiment, a user uses the VMR GUI or mobile device interface to message or email the video or picture directly to a concerned party (Appendix A p.14). With social media integration, the information can be posted online if appropriate. In this manner, the present invention provides a quick and easy way for a user to share the video medical record with the patient, health care professional, and other concerned parties In order to comply with patient privacy laws and HIPAA, the VMR system 18 can identify and distinguish between users so as to appropriately limit the amount of information a particular user has access to.

When a user views an image/picture or video, or listens to an audio recording, the user can add a comment to the information (Appendix E p.1). The GUI interface will list all the comments from each user, which can be accessed by viewing the information to which the comments pertains to. In one embodiment, the patient views a video of himself during gait training and can add a comment directed to the physical therapist expressing gratitude for the video (Appendix D p. 13, Appendix D p. 14, Appendix F p.1). In another embodiment, the doctor can comment the patient should try a different exercise or instruct the physical therapist on another therapy.

Using the VMR system 18, video recording and streaming can happen simultaneously and in real time over an Internet connection, such as in a video conference with two or more parties. In one embodiment, a physical therapist starts recording video of the patient which is shown to the doctor in real time. The doctor may be using a mobile device 12 or desktop computer 14. The doctor can provide real time comments and information to the patient and PT. In another embodiment, the video is streamed online to multiple concerned parties. In yet another embodiment each user can see all other users in the video conference. All recorded video, comments and information from each user can be added to the patient's electronic medical record and stored on the mobile device 12 desktop computer 14, and/or VMR server 10.

In another application of the present invention, the VMR system 18 can facilitate healthcare plan meetings, that is meetings where concerned parties discuss the healthcare of the patient. Concerned parties oftentimes request patient progress from the health care professional. By making pictures and videos available to them, they can view the latest media showing the progress of the patient and compare them to previous pictures or videos (Appendix A p. 18). For optimal comparison purposes, the media taken at differing times will show the patient performing the same movements or bodily tasks. This feature of the present invention is especially valuable to concerned parties who are in remote locations, where the user can send them videos or pictures that they can receive on their own mobile devices 12 (Appendix A p. 18).

In another application of the present invention the VMR system 18 can be used by the patient or other concern parties to provide updated information to the health care professional. The patient would simply send videos and/or pictures with any edits, including progress notes.

In another application of the present invention the videos can be shared immediately with a health care professional to as to receive prompt feedback for assistance with correct posture or ergonomics.

According to the illustrated embodiments, biofeedback using videos improve functional mobility. Through video feedbacks a person with disability will be able to recognize unnecessary movement patterns and correct himself immediately.

According to the illustrated embodiments, mirror therapy using an IPad video is enabled. The synergic effects of mirror therapy is enabled for functional mobility in stroke patients. Using our software we are able to provide a mimic mirror and enable achievement of a synergetic effect on the affected area to improve function during therapy intervention.

According to the illustrated embodiments, video medical records of therapy treatment is enabled. All treatment is documented through videos from the first assessment (evals), daily notes, progress notes (weekly, re-certifications through discharge instead of being documented by written records. All of these are video records enhanced with tolls for accurate assessments and data collection.

The illustrated embodiments of the invention are further illustrated by the attached Appendices which are herein incorporated as if set out in their entirety.

Appendix A shows an embodiment of an instruction manual for a system and method for creating a video medical record. In particular, it shows an example of a graphical user interface (GUI) for a system and method for creating a video medical record. Some material may have been redacted or blacked-out to protect the privacy of individuals.

Appendix B shows another example of a graphical user interface for a system and method for creating a video medical record. Some material may have been redacted or blacked-out to protect the privacy of individuals.

Appendix C shows a diagram of the website, mobile device app for health care professional, and mobile device app for patient

Appendix D shows another example of a graphical user interface for a system and method for creating a video medical record. Some material may have been redacted or blacked-out to protect the privacy of individuals.

Appendix E shows another example of a graphical user interface for a system and method for creating a video medical record. Some material may have been redacted or blacked-out to protect the privacy of individuals.

Appendix F shows another example of a graphical user interface for a system and method for creating a video medical record. Some material may have been redacted or blacked-out to protect the privacy of individuals.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An electronic medical records system including records associated with a patient comprising:
a video medical record (VMR) system including a central server and at least one user device remote from the central server, the video medical record (VMR) system capable of creating, editing, storing, comparing, and sharing a video of the patient; and
a communication link between the central server and the at least one user device remote from the central server.

2. The electronic medical records system of claim 1 where the at least one user device remote from the central server comprises a desktop computer, hospital server, laptop, tablet, laptop-tablet hybrid, phablet, tablet-phone hybrid, phone, or a camera equipped mobile device.

3. The electronic medical records system of claim 1 where the at least one user device remote from the central server comprises a graphical user interface (GUI) that allows a user to create, edit, store, compare, and share one or more videos of the patient.

4. The electronic medical records system of claim 1 where the central server includes the patients' electronic medical records, including pictures, video and audio.

5. The electronic medical records system of claim 1 where the at least one user device remote from the central server comprises a graphical user interface (GUI) that allows a user to add a new patient, retrieve and view all or part of the patient's existing medical record, edit the patient's existing medical record, or create a new medical record by inputting the patient's identification information such as the patient's name, email address, medical record number, or annotating textual information.

6. The electronic medical records system of claim 1 where the at least one user device remote from the central server comprises a graphical user interface (GUI) that allows a user to:
browse or a list of patients or search existing patients for a specific patient's medical record information provided by the central server;
view videos, images, or reports of the selected patient;
listen to any audio record present; or
add or edit information to the medical record of the selected patient including vital measurements, diagnosis, treatment, or progress reports of that patient, texts, pictures, or video.

7. The electronic medical records system of claim 1 where the at least one user device remote from the central server comprises a graphical user interface (GUI) that allows a user to access only specific functions and information, or all functions and information provided by central server depending on a qualification given to the user.

8. The electronic medical records system of claim 1 where the at least one user device remote from the central server comprises a graphical user interface (GUI) that allows a user to record a video, edit a video and perform data or recording functionalities, notify another user when there is new information or new update on the central server, or determine whether or not the patient has seen a selected video.

9. The electronic medical records system of claim 1 where the at least one user device remote from the central server comprises a graphical user interface (GUI) that allows a user to view pictures/images, video, listen to audio, use a website provided by the central server to register, view a patient's medical record, or send an email or notification to the patient or selected health care professionals, users, or concerned parties using social media.

10. The electronic medical records system of claim 1 where the at least one user device remote from the central server comprises a graphical user interface (GUI) that allows a user to rename a saved video, viewed and played by itself, adjust a speed at which the video is played, play a video in comparison with other videos from the same patient or different patients, display two or more videos on the same screen or viewing area, side by side or close proximity to each other, play each video independently or simultaneously while in close proximity to a display of another video.

11. The electronic medical records system of claim 1 where the at least one user device remote from the central server comprises a graphical user interface (GUI) that allows a user to edit and manipulate an image/picture, video, or audio when viewed by itself or while in comparison with other images/pictures or videos, add pictures, drawings, markings, shapes or text, angle recognition, free drawing pencil marks, or four point angles to one or more selected frames of a video, edit one or more selected frames of the video, add a new frame with edits inserted between existing frames, add one layer or multiple layers of edits to a frame or multiple frames, add different edits separately to each frame of a video, save an edited video as an additional new video or replace an original video, take a snapshot of a frame of the video and save it as a picture, or show videos or pictures in comparison with other videos or pictures from the same patient or different patients.

12. The electronic medical records system of claim 1 where the communication link comprises a local area network, wide area network, cloud computing network, or internet connected wirelessly using cellular technology, satellite, or any wireless protocols.

13. A method of using an electronic medical records system including a central server and at least one user device remote from the central server comprising:
creating a video medical record (VMR) in the video medical record system;
storing the video medical record (VMR) in the video medical record system;
editing the video medical record (VMR) in the video medical record system;
comparing the video medical record (VMR) in the video medical record system; and
sharing the video medical record (VMR) in the video medical record system.

14. The method of claim 13 where creating, storing, editing, comparing, and sharing the video medical record (VMR) in the video medical record system comprises creating, storing, editing, comparing, and sharing the video medical record (VMR) in a desktop computer, hospital server, laptop, tablet, laptop-tablet hybrid, phablet, tablet-phone hybrid, phone, or a camera equipped mobile device.

15. The method of claim 13 where creating, storing, editing, comparing, and sharing the video medical record (VMR) in the video medical record system comprises creating, storing, editing, comparing, and sharing one or more videos of a patient using a graphical user interface (GUI) in the at least one user device remote from the central server.

16. The method of claim 13 where creating, storing, editing, comparing, and sharing the video medical record (VMR) in the video medical record system comprises creating, storing, editing, comparing, and sharing a patients' electronic medical records, including pictures, video or audio.

17. The method of claim 1 where creating, storing, editing, comparing, and sharing the video medical record (VMR) in the video medical record system comprises using a graphical user interlace (GUI) to edit and manipulate an image/picture, video, or audio when viewed by itself or while in comparison with other images/pictures or videos, add pictures, drawings, markings, shapes or text, angle recognition, free drawing pencil marks, or four point angles to one or more selected frames of a video, edit one or more selected frames of the video, add a new frame with edits inserted between existing frames, add one layer or multiple layers of edits to a frame or multiple frames, add different edits separately to each frame of a video, save an edited video as an additional new video or replace an original video, take a snapshot of a frame of the video and save it as a picture, or show videos or pictures in comparison with other videos or pictures from the same patient or different patients.

18. The method of claim 13 where creating, storing, editing, comparing, and sharing the video medical record (VMR) in the video medical record system comprises using a graphical user interlace (GUI) to rename a saved video, viewed and played by itself, adjust a speed at which the video is played, play a video in comparison with other videos from the same patient or different patients, display two or more videos on the same screen or viewing area, side by side or in close proximity to each other, play each video independently or simultaneously while in close proximity to a display of another video.

19. The method of claim 13 where creating, storing, editing, comparing, and sharing the video medical record (VMR) in the video medical record system comprises using a graphical user interface (GUI) to view pictures/images, video, listen to audio, use a website provided by the central server to register, view a patient's medical record, or send an email or notification to the patient or selected health care professionals, users, or concerned parties using social media.

20. The method of claim 13 where creating, storing, editing, comparing, and sharing the video medical record (VMR) in the video medical record system comprises using a graphical user interface (GUI) to record a video, edit a video and perform data or recording functionalities, notify another user when there is new information or new update on the central server, or determine whether or not the patient has seen a selected video.
